(19) United States
(12) Patent Application Publication
(10) Pub. No.: US 2009/0064592 A1
(43) Pub. Date: Mar. 12, 2009

(54) Automotive glass run

(75) Inventors: Tomohiro Takase, Aichi-ken (JP); Masanori Aritake, Aichi-ken (JP); Satoshi Toki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Toyoda Gosei Co., Ltd., Nishikasugai-gun (JP)

(21) Appl. No.: 12/230,515

(22) Filed: Aug. 29, 2008

(30) Foreign Application Priority Data
Aug. 31, 2007 (JP) P2007-225489

(51) Int. Cl. B60J 1/16

(52) U.S. Cl. 49/374

(57) ABSTRACT

In automotive glass run, a main body of glass run assumes a substantially U-shaped cross section consisting of a vehicle-exterior side wall, a vehicle-interior side wall, and a bottom wall. The vehicle-exterior side wall and the vehicle-interior side wall are provided with a vehicle-exterior seal lip and a vehicle-interior seal lip that extend to the inside of the main body of the substantially U-shaped cross section. The vehicle-exterior side wall is formed with a solid material or a microfoaming solid material, and the vehicle-interior side wall and the bottom wall are formed with a sponge material.

### BACKGROUND OF THE INVENTION

1. Field of the Invention

The present invention relates to a glass run that is attached to inner peripheral parts of longitudinal sides of a door frame of an automotive door and that guides ascending and descending operations of door glass.

2. Related Art

As shown in FIG. 3, glass run 110 for guiding ascending and descending operations of door glass 5 is attached to an inner peripheral part of a door frame 2 of an automotive door 1. The entirety of the related-art glass run 110 is shown in FIG. 2, and a cross-sectional view of the related-art glass run 110 attached to linear portions of the door frame 2 is shown in FIGS. 4 and 5.

Conventionally, the glass run 110 is attached to the inside of a channel of the door frame 2 as shown in FIG. 3, to thus guide the ascending and descending operations of the door glass 5 and seal a space between the door glass 5 and the door frame 2. Further, as shown in FIG. 2, the glass run 110 connects an upper side portion of the door frame 2, which is formed with linear portions 111 formed through extrusion molding, to front longitudinal sides and rear longitudinal sides, which are similarly formed through extrusion molding, by corners 112 that is die-molded in conformance with the shape of corners 2b of the door frame 2.

A seal between the door 1 and a vehicle body is formed with a door weather strip (not shown) attached to an outer peripheral part of a door panel and the outer peripheral part of the door frame 2 and/or an opening trim weather strip (not shown) attached to flanges of openings of the vehicle body.

As shown in FIG. 4, the linear portions 111 of the main body of the glass run 110 constitute a substantially U-shaped cross section consisting of a vehicle-exterior side wall 120, a vehicle-interior side wall 130, and a bottom wall 140. An external seal lip 121 is provided so as to extend from the vicinity of the leading end of the vehicle-exterior side wall 120 toward an inside of the substantially U-shaped area of the main body. Moreover, an internal vehicle seal lip 131 is provided even on the vehicle-interior side wall 130 so as to extend from the vicinity of a leading end of the vehicle-interior side wall 130 toward the inside of the substantially U-shaped cross section.

The vehicle-exterior side wall 120, the vehicle-interior side wall 130, and the bottom wall 140 of the main body of the glass run 110 are inserted to a channel 103 formed in the door frame 2, and at least portions of vehicle-exterior surfaces of the walls are brought into pressed contact with a vehicle-interior surface of the channel 103, to thus hold the glass run 110. As shown in FIG. 4, there are cases where the channel 103 is made by bending the door frame 2 or where the channel 103 is made by fitting a channel formed with a separate member.

The door glass 5 performs slidable movement over the inside of that main body of the glass run 110 which has a substantially U-shaped cross section, and both side surfaces of an edge of the door glass 5 are sealed and held by the vehicle-exterior wind lip 121 and the vehicle-interior seal lip 131 (see; for instance, JP-A-2005-349869).

In order to hold the glass run 110 in the channel 103 in an engaged manner when the glass run 110 is attached into the channel 103, the vehicle-interior side wall 130 and the vehicle-exterior side wall 120 are provided with a vehicle-interior hold lip 134 and a vehicle-exterior projection 124 at linear portions of the glass run 110.

The vehicle-exterior side wall 120, the vehicle-interior side wall 130, and the bottom wall 140 of the main body of the glass run 110 are formed with an ordinary solid material, such as rubber or a synthetic resin and exhibit large specific gravity. In some glass run, the vehicle-exterior seal lip 121 and the vehicle-interior seal lip 131 are kneaded with a magnetic substance. For these reasons, the overall weight of the glass run 110 becomes great, which defies a recent request for a reduction in the weight of the vehicle.

Therefore, as shown in FIG. 5, there is available glass run 210 in which a vehicle-interior side wall 230, a vehicle-interior seal lip 231, and a bottom wall 240 are formed with microfoaming rubber; in which a root portion of a vehicle-exterior side wall 220 determined with reference to an appearance line OL222 is formed with microfoaming rubber; and in which a leading-edge side of the vehicle-exterior side wall 220 determined with reference to the appearance line OL222 and the vehicle-exterior seal lip 221 are formed with solid rubber (see; for instance, JP-A-2004-196033).

However, the great majority of the glass run 210 is formed with microfoaming rubber and hence presents a problem of a slight reduction in specific gravity and a failure to achieve sufficient weight reduction.

### SUMMARY OF THE INVENTION

Accordingly, the present invention aims at providing a glass run that yields a large weight-reduction effect and that can exhibit sufficient sealing characteristics even at the time of ascending or descending operation of door glass.
In order to solve the problem, a first aspect of the invention provides an automotive glass run attached to an inner peripheral part of an upper side of a door frame of an automotive door and that guides ascending and descending a door glass, comprising:
a main body having a substantially U-shaped cross section formed with a vehicle-exterior side wall, a vehicle-interior side wall and a bottom wall;
wherein the vehicle-exterior side wall is provided with a vehicle-exterior seal lip extending to an inside of the main body and the vehicle-interior side wall is provided with a vehicle-interior seal lip extending to an inside of the main body;
a vehicle-exterior side surface of an edge of the door glass and a vehicle-interior side surface of the edge of the door glass are sealed with the vehicle-exterior seal lip and the vehicle-interior seal lip, respectively; and
the vehicle-exterior side wall is formed with a solid material or a microfoaming solid material, and the vehicle-interior side wall and the bottom wall are formed with a sponge material.

In the first aspect of the present invention, a main body of the glass run in a linear portion assumes a substantially U-shaped cross section formed with a vehicle-exterior side wall, a vehicle-interior side wall, and a bottom wall. The vehicle-exterior side wall and the vehicle-interior side wall are provided with a vehicle-exterior seal lip and a vehicle-interior seal lip that extend toward the inside of the main body of a substantially U-shaped cross section. Further, a vehicle-exterior side surface and a vehicle-interior side surface of both side edges of the door glass are sealed with the vehicle-exterior seal lip and the vehicle-interior seal lip.

Consequently, when the door is closed, the leading edge of the door glass can be housed, at an upper side and a longitudinal side of the door frame, in the glass run having the main body of a substantially U-shaped cross section consisting of the vehicle-exterior side wall, the vehicle-interior side wall, and the bottom wall, so that the door glass can be securely held. Further, the vehicle-exterior seal lip and the vehicle-interior seal lip contact the door glass, at the upper sides and longitudinal sides of the linear portions, along with ascending or descending operation of the door glass, whereby the space between the door frame and the door glass can be sealed with the vehicle-exterior seal lip and the vehicle-interior seal lip.

The vehicle-exterior side wall is made of a solid material or a microfoaming solid material and hence exhibits high rigidity. When the door glass ascends, to thus enter the main body of the glass run, anomalous deformation of the vehicle-exterior side wall, which would otherwise be caused by the leading edge of the door glass, does not arise, so that a sealing characteristic can be assured without fail. The glass run does not project from the door frame, and superior appearance is yielded. Further, since the solid material or the microfoaming solid material is used, a smooth surface and a preferable design are achieved.

The vehicle-interior side wall and the bottom wall are formed with a sponge material, and hence an area accounting for a large proportion of the entire volume of the glass run can be produced from a sponge material having small specific gravity, so that the overall weight of the glass run can be greatly reduced, to thus contribute to weight reduction of a vehicle.

Since the vehicle-interior side wall is formed so as to become larger and thicker than the vehicle-exterior side wall, anomalous deformation, which would otherwise be caused by ascending and descending operations of the door glass, does not arise even when the glass run is formed with a sponge material.

A second aspect of the invention is directed to automotive glass run, wherein specific gravity of the sponge material ranges from 0.3 to 0.8.

In the second aspect of the invention, the vehicle-interior side wall and the bottom wall, which account for large proportions of the overall volume of the glass run, are formed with a sponge material whose specific gravity ranges from 0.3 to 0.8. Hence, the entire glass run has small specific gravity, and the overall weight of the glass run can be greatly reduced.

A third aspect of the invention is directed to automotive glass run, wherein specific gravity of the solid material or the microfoaming solid material ranges from 0.8 to 1.2.

In the third aspect of the invention, the vehicle-exterior side wall, and the like, is formed form a solid material or a microfoaming solid material whose specific gravity ranges from 0.8 to 1.2. Hence, rigidity can be maintained without an increase in the weight of the portion consisting of the solid material.

A fourth aspect of the invention is directed to automotive glass run, wherein the vehicle-exterior seal lip is formed with a solid material or a microfoaming solid material.

In the fourth aspect of the invention, the vehicle-exterior seal lip is formed with a solid material or a microfoaming solid material. Hence, even when a leading edge of the door glass contacts the vehicle-exterior seal lip as a result of ascending of the door glass, the seal lip contacts side surfaces of the leading edge of the door glass without involvement of anomalous deformation, thereby holding and sealing the door glass.

A fifth aspect of the invention is directed to automotive glass run, wherein the vehicle-interior side wall and the vehicle-interior seal lip are formed so as to become larger and thicker than the vehicle-exterior side wall and the vehicle-exterior seal lip, respectively.

In the fifth aspect of the invention, the vehicle-interior side wall and the vehicle-interior seal lip of glass run are formed so as to become larger and thicker than the vehicle-exterior side wall and the vehicle-exterior seal lip, respectively. Hence, the door glass can be held without fail, and the door glass can be positioned in a direction outside of the vehicle. A step between the door glass and the door frame can be reduced, and a reduction in wind sound and superior appearance can be achieved. Further, the area of a vehicle-exterior-side area of the door frame or door molding can be reduced, so that preferable design is offered.

A sixth aspect of the invention is directed to automotive glass run, wherein a recess is formed in a vehicle-exterior surface of the vehicle-exterior side wall, and an end of the door frame or an end of a door molding is fitted into the recess, thereby holding the vehicle-exterior side wall.

In the sixth aspect of the invention, a recess is formed in a vehicle-exterior surface of the vehicle-exterior side wall, and an edge of the door frame or an edge of a door molding is fitted into the recess, thereby holding the vehicle-exterior side wall. Therefore, the vehicle-exterior side wall is held by the door frame or the door molding without fail, whereby the space between the vehicle-exterior side wall and the door glass is thoroughly sealed without involvement of removal of the vehicle-exterior side wall even when the door glass ascends or descends, and the external appearance of the vehicle can be enhanced.

A seventh aspect of the invention is directed to an automotive glass run, wherein a low sliding resistance material layer is formed on a surface of the vehicle-exterior seal lip and a surface of the vehicle-interior seal lip.

In the seventh aspect of the invention, the low sliding resistance material layer is formed on the surface of the vehicle-exterior seal lip and the surface of the vehicle-interior seal lip. Even when the door glass enters the main body of the glass run, to thus make sliding operation, sliding resistance between the vehicle-exterior seal lip and the vehicle-interior seal lip can be lessened, so that smooth ascending and descending operations of the door glass can be maintained.

An eighth aspect of the invention is directed to automotive glass run, wherein a low sliding resistance material layer is formed on a surface of the bottom wall.

In the eight aspect of the invention, since the low sliding resistance material layer is formed on the surface of the bottom wall, close contact of the door glass with the bottom wall and generation of an unusual sound can be prevented even when the door glass ascends, to thus enter the main body of the glass run and contact the bottom ball.

A ninth aspect of the invention is directed to automotive glass run, wherein a cover lip is formed on a leading end of the vehicle-interior side wall, and the cover lip contacts a side edge of a garnish attached to a vehicle-interior side edge of the door frame or a vehicle-interior side of the door frame.

In the ninth aspect of the invention, the cover lip is formed on the leading edge of the vehicle-interior side wall, and the cover lip contacts the garnish attached to the vehicle-interior side edge of the door frame or the inside of the door frame. Therefore, clearance between the vehicle-interior side edge of the door frame or the side edge of the garnish attached to the inside of the door frame and the door glass is covered, to thus offer superior appearance.

In the present invention, the vehicle-exterior side wall is made of a solid material or a microfoaming solid material and hence exhibits high rigidity. Anomalous deformation of the vehicle-exterior side wall, which would otherwise be caused by the leading edge of the door glass, does not arise, so that a sealing characteristic can be assured without fail and that superior appearance is also offered. Moreover, since the solid material or the microfoaming solid material is used, a smooth surface and a preferable design are obtained.

The vehicle-interior side wall and the bottom wall are produced from a sponge material, so that areas accounting for large proportions of the overall volume of the glass run can be formed with a sponge material having low specific gravity, to enable a great reduction in the entire volume of the glass run and contribute to weight reduction of a vehicle.

### BRIEF DESCRIPTION OF THE DRAWINGS

FIG. 1 is a cross-sectional view of glass run, which is an embodiment of the present invention and in a state of being attached to an upper side, taken along line A-A shown in FIG. 3;

FIG. 2 is a front view of the glass run that is the embodiment of the present invention;

FIG. 3 is a front view of an automotive door;

FIG. 4 is a cross-sectional view of the related-art glass run attached to the upper side; and

FIG. 5 is a perspective view of another related-art glass run attached to the upper side.

### DETAILED DESCRIPTION OF THE PREFERRED EMBODIMENTS

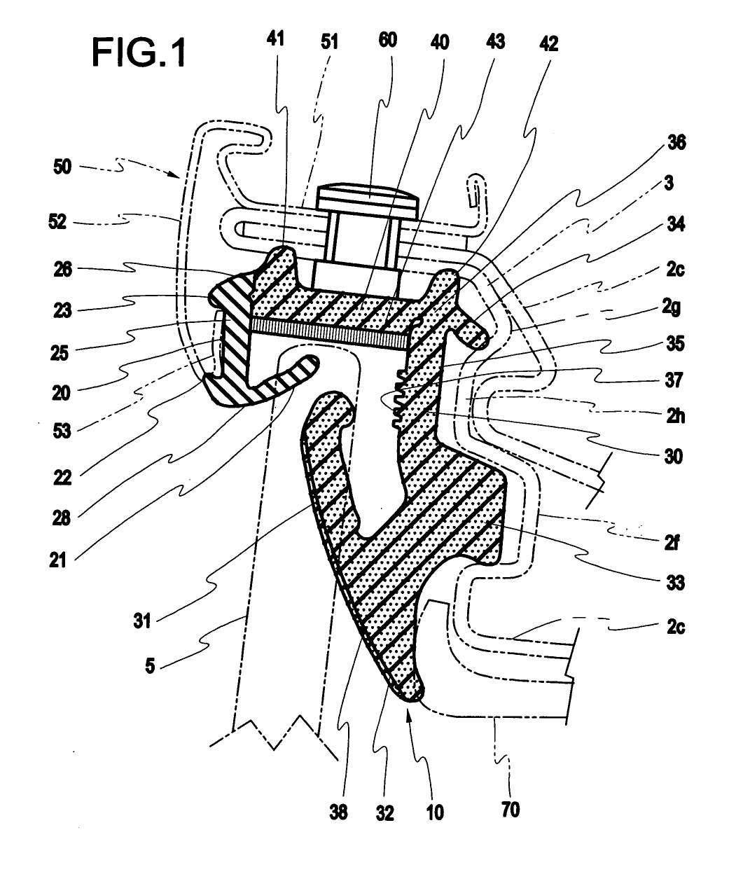

An embodiment of the present invention will be described by reference to FIGS. 1 through 3.

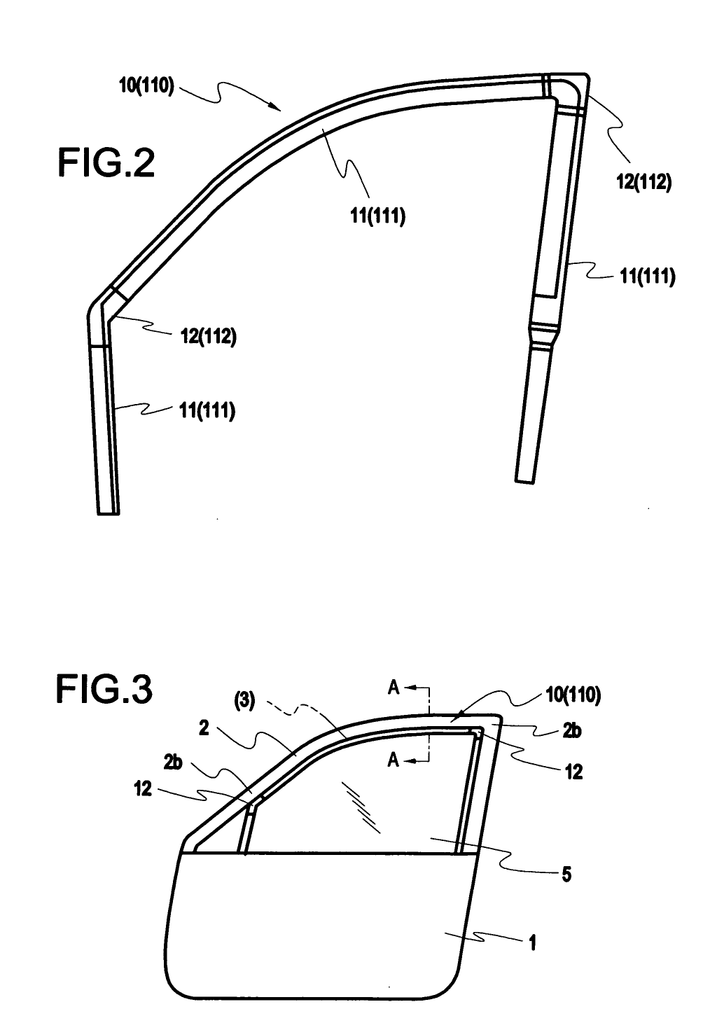

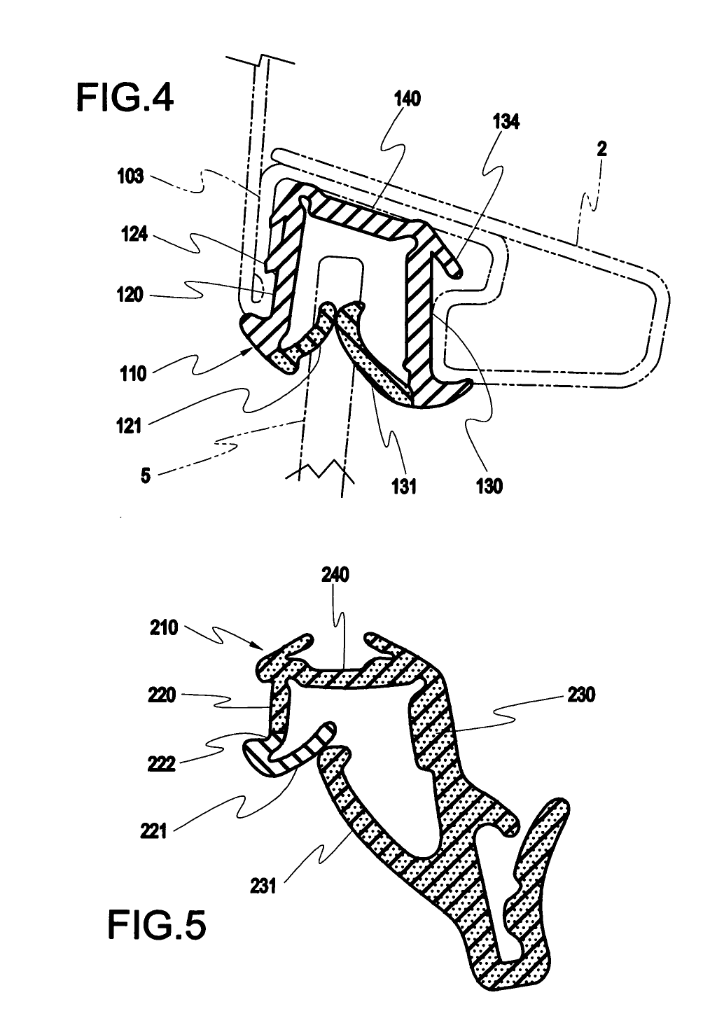

FIG. 3 is a front view of a front door 1 of an automobile, and FIG. 2 is a front view of glass run 10 of the front door to be attached to a door frame 2 of the door 1. As shown in FIG. 3, the door frame 2 is attached to an upper portion of the door 1, and door glass 5 is attached to the door frame so as to be able to freely ascend or descend. Specifically, the glass run 10 is attached to an inner peripheral part of the door frame 2, thereby guiding ascending and descending operations of the door glass 5 and sealing a gap between the door glass 5 and the door frame 2.

As shown in FIG. 2, the glass run 10 includes linear portions 11 wholly formed by extrusion molding and corners 12 that are to be attached to corners 2b of the door frame 2, to thus interconnect the linear portions 11, and that are formed by die molding.

Each of the linear portions 11 includes an area that is to be attached to the upper side of the door frame 2; an area that is to be attached to a rear longitudinal side of the door frame 2; and an area that is to be attached to a division sash constituting a front longitudinal side of the door frame 2.

The extrusion-molded areas are molded by die molding at respective front and rear corners so as to assume a shape conforming to the door frame 2, and the thus-molded areas are connected to the linear portions 11, thereby forming the corners 12. The corners 12 of the glass run 10 are attached to the corners 2b of the door frame 2.

The following descriptions are provided by means of taking, by way of example, the glass run 10 attached to the upper side of the front door 1.

FIG. 1 is a cross-sectional view of the glass run 10 attached to the upper side of the door frame 2 taken along line A-A shown in FIG. 3.

In relation to a cross-sectional profile of each of the linear portions 11 of the glass run 10 attached to the upper sides of the door frame 2, the main body of the linear portion is formed so as to assume a substantially U-shaped cross section, as shown in FIG. 1 made up of a vehicle-exterior side wall 20, a vehicle-interior side wall 30, and a bottom wall 40. As will be described later, the vehicle-interior side wall 30 is formed so as to become larger and thicker than the vehicle-exterior side wall 20, and a vehicle-interior part of the substantially U-shaped cross section is formed into a large asymmetrical shape.

In the main body of the glass run 10, a portion of the main body attached to the upper side of the door frame 2 and a portion of the same attached to the longitudinal side of the door frame basically assume an essentially-similar U-shaped cross-sectional profile.

The glass run 10 of the present invention is attached to the upper side of the door frame 2, and a door molding 50 is attached to an outer peripheral surface of a leading edge of the door frame 2. The leading edge of the door frame 2 is bent to form a channel 3 having an essentially-L-shaped cross section. The glass run 10 is held by the channel 3 and the door molding 50.

In the door molding 50, a door molding mount section 51 serving as one edge is attached to a horizontal surface located close to the leading edge of the door frame 2 by a mount screw 60, or the like. A door molding decoration section 52 bent from the door molding mount section 51 covers the leading edge of the door frame 2, to thus constitute a decoration section in the outer peripheral part of the door frame 2.

An edge of the door molding decoration section 52 is bent to the rear side in the shape of a hairpin, to thus constitute a door molding hold section 53. The door molding hold section 53 is fitted into a vehicle-exterior hold recess 25 to be described later, to thus hold the vehicle-exterior side wall 20.

The glass run 10 can also be held without use of the door molding 50 by means of bending the door frame 2 to form the channel 3 having an essentially-U-shaped cross section.

The vehicle-exterior side wall 20 of the glass run 10 is formed into an essentially-plate-shaped cross section.

The vehicle-interior seal lip 21 is formed so as to extend from the vicinity of a leading edge of the vehicle-exterior side wall 20 to the inside of the substantially U-shaped cross section of the main body. Further, the vehicle-exterior cover lip 22 is formed so as to extend from the leading edge of the vehicle-exterior side wall 20 to the outside of the vehicle. The vehicle-exterior cover lip 22 covers a leading edge of the door molding 50.

The portion having a substantially U-shaped cross section is formed with the door molding 50 and a leading edge of an outer panel 2c of the door frame 2, and the glass run 10 is held in that portion.

Further, the vehicle-exterior side wall 20 is formed so as to become smaller than the vehicle-interior side wall 30 to be described later, so that the area of a portion of the door molding 50 located outside the vehicle can be reduced, to thus offer design preference.

A vehicle-exterior projection 23 is formed on a part of the vehicle-exterior surface of the vehicle-exterior side wall 20 close to the bottom wall 40. The vehicle-exterior hold recess 25 is formed between the vehicle-exterior projection 23 and the vehicle-exterior cover lip 22. As mentioned above, the door molding hold section 53 is fitted into the vehicle-exterior hold recess 25, to thus hold the vehicle-exterior side wall 20.

Thereby, the vehicle-exterior side wall 20 can be securely held by the door molding 50. Therefore, even when the door glass 5 ascends or descends, disconnection of the vehicle-exterior side wall 20 from the door molding 50, which would be caused when the side wall is dragged by the door glass 5, does not arise, and secure seal is realized. Further, the door glass 5 does not project outside of the vehicle, so that exterior appearance of the vehicle can be enhanced.

The exterior side wall 20 is formed with a solid material or a microfoaming solid material of rubber or a thermoplastic elastomer. Therefore, the vehicle-exterior side wall exhibits high rigidity. Even when a leading edge of the door glass 5 becomes displaced to thus contact a leading edge of the vehicle-exterior side wall 20 when the door glass 5 ascends, to thus enter the main body of the glass run 10, anomalous deformation of the vehicle-exterior side wall 20 does not arise, so that a sealing characteristic can be securely ensured. Combined with the fact that the foregoing vehicle-exterior hold recess 25 is held by the door molding 50, the glass run 10 does not project from the door frame 2, so that superior appearance is achieved. Further, the vehicle-exterior side wall is formed with the solid material or the microfoaming solid material, a smooth surface is achieved, and a preferable design is also acquired.

The vehicle-exterior side wall 20 is made of a solid material or a microfoaming solid material, specific gravity of which ranges from 0.8 to 1.2. In the case of the microfoaming solid material, specific gravity is of the order of 0.8 to 1.0. In the case of the solid material, specific gravity is of the order of 1.0 to 1.2. Therefore, an increase in weight of the vehicle-exterior side wall can be prevented while the rigidity of the vehicle-exterior side wall 20 is maintained.

Compared with the vehicle-interior side wall 30, the vehicle-exterior side wall 20 has a smaller volume. Even when specific gravity of the vehicle-exterior side wall is of the order of 0.8 to 1.2, the chance of an increase in the overall weight of the glass run 10 is small.

The vehicle-exterior side wall 20 is joined to the bottom wall 40 by a vehicle-exterior joint 26. A groove is formed in a vehicle-interior surface of the vehicle-exterior joint 26. Even when the vehicle-exterior side wall 20 and the vehicle-interior side wall 30 become wide open in the form of slanting eyebrows with respect to the bottom wall 40 during manufacture, the area between the vehicle-exterior side wall 20 and the bottom wall 40 becomes easy to deflect when the channel 3 is attached to the glass run 10, thereby facilitating attachment operation.

The vehicle-exterior seal lip 21 is obliquely extended from the leading edge of the vehicle-exterior side wall 20 to the inside of the main body of the glass run 10. Both side surfaces of the leading edge of the door glass 5 are held by the vehicle-exterior seal lip 21 and the vehicle-interior seal lip 31 to be described later. Along with ascending and descending operations of the door glass 5, the vehicle-exterior wind lip 21 and the vehicle-interior seal lip 31 to be described later contact side surfaces of the door glass 5, thereby sealing the space between the door frame 2 and the door glass 5.

The vehicle-exterior seal lip 21 is preferably formed with a solid material or microfoaming solid material of rubber or thermoplastic elastomer, as is the vehicle-exterior side wall 20. In this case, high rigidity is attained. When the door glass 5 ascends, to thus enter the main body of the glass run 10, the vehicle-exterior seal lip securely holds the door glass 5, so that a sealing characteristic can be assured.

Low sliding resistance material layers 28 and 38 can be formed on the surface of the vehicle-exterior seal lip 21 and the surface of the vehicle-interior seal lip 31. In this case even when the door glass 5 enters the main body of the glass run 10 and performs slidable movement, sliding resistance arising among the vehicle-exterior seal lip 21, the vehicle-interior seal lip 31, and the door glass 5 can be lessened, and smooth ascending and descending operations of the door glass 5 can be maintained.

The low sliding resistance material layers 28 and 38 can be produced by simultaneous extrusion of a material, which contains a large proportion of olefin in thermoplastic elastomer and which exhibits low sliding resistance material resistance, to a thickness of the order of 0.1 mm over the surface of the vehicle-exterior seal lip 21 and the vehicle-interior seal lip 31 or by application of a silicon resin or an urethane resin.

A low sliding resistance material layer or a ridge can also be formed on the vehicle-interior surface of the vehicle-exterior seal lip 21 or the vehicle-interior surface of the vehicle-exterior side wall 20. In this case, occurrence of close contact between the vehicle-exterior side wall 20 and the vehicle-exterior seal lip 21, which would otherwise arise when the door glass 5 enters the main body of the glass run 10, can be prevented, and prevention of generation of an unusual sound and assurance of a sealing characteristic can be achieved.

The vehicle-interior side wall 30 is produced so as to become thicker and greater than the vehicle-exterior side wall 20. Therefore, the glass run 10 can be firmly held on the door frame 2.

Moreover, since the vehicle-interior side wall 30 is produced so as to become thicker and greater than the vehicle-exterior side wall 20, the door glass 5 can be oriented in the outside direction of the vehicle within the main body of the glass run 10. A step between the door glass 5 and the door molding 50 can be reduced, so that a wind sound can be lessened and superior appearance can be provided.

The vehicle-interior side wall 30 is formed with a sponge material. As shown in FIG. 1, the vehicle-interior side wall 30 is larger than the vehicle-exterior side wall 20 and accounts for a large proportion of the entire volume of the glass run 10. Such a large proportion of the glass run can be produced from a sponge material having small specific gravity, so that the overall weight of the glass run 10 can be greatly reduced, to thus contribute to weight reduction of a vehicle.

The specific gravity of the sponge material preferably ranges from 0.3 to 0.8. When the vehicle-interior side wall 30 is produced from a sponge material whose specific gravity ranges from 0.3 to 0.8, the overall weight of the glass run 10 can be greatly reduced.

The vehicle-interior projection 33 is formed on a leading-edge side of an exterior surface of the vehicle-interior side wall 30, and a vehicle-interior hold lip 34 is formed in the vicinity of an area continuous to the bottom wall 40. Recesses 2f, 2g are formed by bending two locations on the outer panel 2c of the door frame 2, and the vehicle-interior projection 33 and the vehicle-interior hold lip 34 are engaged with the recesses 2f, 2g. Therefore, the glass run 10 is held on the door frame 2 by the foregoing door molding 50 and the recesses. 2f, 2g, thereby sealing the space between the vehicle-interior side wall 30 and the outer panel 2c.

A vehicle-interior hold recess 35 is formed between the vehicle-interior projection 33 and the vehicle-interior hold lip 34, and a projection 2h of the outer panel 2c is fitted into the vehicle-interior hold recess 35, thereby holding the vehicle-interior side wall 30. Therefore, along with the holding effects of the vehicle-interior projection 33 and the vehicle-interior hold lip 34, the vehicle-interior side wall 30 can be securely held.

The vehicle-interior side wall 30 is joined to the bottom wall 40 by a vehicle-interior joint 36. A groove is formed in a vehicle-interior surface of the vehicle-interior joint 36. When the channel 3 is attached to the glass run 10, the area between the vehicle-interior side wall 30 and the bottom wall 40 becomes easy to deflect, thereby facilitating attachment operation, as in the case of the vehicle-exterior joint 26.

A plurality of vehicle-interior ridges 37 are continually formed on the vehicle-interior surface of the vehicle-interior side wall 30 in a longitudinal direction. Even when the leading edge of the vehicle-interior seal lip 31, which will be described later, is brought into pressed contact with the vehicle-interior surface of the vehicle-interior side wall 30 as a result of the door glass 5 entering the main body of the glass run 10, close contact of the leading edge of the vehicle-interior seal lip 31 with the vehicle-interior surface of the vehicle-interior side wall 30 can be prevented, to thus prevent generation of an unusual sound.

The vehicle-interior seal lip 31 is provided so as to obliquely extend from the leading edge of the vehicle-interior side wall 30 toward the inside of the main body of the glass run 10. As mentioned previously, both side surfaces of the leading edge of the door glass 5 are held between the vehicle-interior seal lip 31 and the vehicle-exterior seal lip 21. In accordance with ascending or descending operation of the door glass 5, the vehicle-interior seal lip 31 and the vehicle-exterior seal lip 21 contact the side surfaces of the door glass 5, so that the space between the door frame 2 and the door glass 5 can be sealed.

The vehicle-interior seal lip 31 is formed with a sponge material as is the vehicle-interior side wall 30. The vehicle-interior seal lip 31 can be produced from a sponge material having low specific gravity, so that the overall weight of the glass run 10 can be greatly reduced, to thus contribute to weight reduction of the vehicle.

The specific gravity of the sponge material preferably ranges from 0.3 to 0.8. When the vehicle-interior seal lip 31 is produced from a sponge material whose specific gravity ranges from 0.3 to 0.8, the overall weight of the glass run 10 can be greatly reduced.

As mentioned previously, a low sliding resistance material layer 38 can be produced on the surface of the vehicle-interior seal lip 31. In this case, sliding resistance existing between the vehicle-interior seal lip 31 and the door glass 5 can be reduced, so that smooth ascending or descending operation of the door glass 5 can be maintained.

The low sliding resistance material layer 38 can be produced by application of a material, which contains a large proportion of olefin in thermoplastic elastomer and which exhibits low sliding resistance, or a silicon resin or an urethane resin, as in the case of the vehicle-exterior seal lip 21.

The vehicle-interior cover lip 32 is provided so as to extend from the leading edge of the vehicle-interior side wall 30 in an upwardly-slanting direction. The vehicle-interior cover lip 32 is formed so as to cover an interior flexion of the outer panel 2c of the door flame 2 and a leading edge of a garnish 70 attached to the vehicle-interior side of the door frame 2. Thus, clearance among the outer panel 2c, the garnish 70, and the door glass 5 is sealed, to thus provide superior appearance.

The bottom wall 40 is essentially formed into the shape of a plate, and a groove is formed in a continual area between the vehicle-interior side wall 30 and the vehicle-exterior side wall 20 so as to facilitate generation of the flexion. Bottom wall seal lips 41 and 42 are formed on a vehicle-exterior side edge of the vehicle-exterior surface of the bottom wall 40 and contact a bottom surface of the outer panel 2c, to thus seal a space between the door frame 2 and the glass run 10.

A bottom wall low sliding resistance material layer 43 is formed on that vehicle-interior surface of the main body of the glass run 10 of the bottom wall 40 which has a substantially U-shaped cross section, as in the case of the vehicle-exterior seal lip 21 and the vehicle-interior seal lip 31. Therefore, sliding resistance arising between the door glass 5 and the glass run of the bottom wall can be reduced. The bottom wall low sliding resistance material layer 43 can be made by flocking short fiber.

During molding of the linear portions 11 of the glass run 10, a solid material of a thermoplastic elastomer or EPDM rubber and a sponge material are used as molding materials. A polyolefin-based elastomer, or the like, is used as the thermoplastic elastomer. In the case of the EPDM rubber, the rubber is heated and cured after being subjected to extrusion molding.

The corners 12 of the glass run 10 are also formed with EPDM rubber or an olefin-based thermoplastic elastomer. These materials are of the same type, and superior adhesion between the linear portions 11 and the corners 12 of the glass run 10 is achieved. Each of these materials is an olefin-based material, and hence there can be obtained products which exhibit superior weatherability, which can be simultaneously pulverized, and which are easy to recycle.

What is claimed is:

1. An automotive glass run attached to an inner peripheral part of an upper side of a door frame of an automotive door and that guides ascending and descending a door glass, comprising:
a main body having a substantially U-shaped cross section formed with a vehicle-exterior side wall, a vehicle-interior side wall and a bottom wall;
wherein the vehicle-exterior side wall is provided with a vehicle-exterior seal lip extending to an inside of the main body and the vehicle-interior side wall is provided with a vehicle-interior seal lip extending to an inside of the main body;
a vehicle-exterior side surface of an edge of the door glass and a vehicle-interior side surface of the edge of the door glass are sealed with the vehicle-exterior seal lip and the vehicle-interior seal lip, respectively; and
the vehicle-exterior side wall is formed with a solid material or a microfoaming solid material, and the vehicle-interior side wall and the bottom wall are formed with a sponge material.

2. The automotive glass run according to claim 1, wherein specific gravity of the sponge material ranges from 0.3 to 0.8.

3. The automotive glass run according to claim 1, wherein specific gravity of the solid material or the microfoaming solid material ranges from 0.8 to 1.2.

4. The automotive glass run according to claim 1, wherein the vehicle-exterior seal lip is formed with a solid material or a microfoaming solid material.

5. The automotive glass run according to claim 1, wherein the vehicle-interior side wall and the vehicle-interior seal lip are formed so as to become larger and thicker than the vehicle-exterior side wall and the vehicle-exterior seal lip, respectively.

6. The automotive glass run according to claim 1, wherein a recess is formed in a vehicle-exterior surface of the vehicle-exterior side wall, and an end of the door frame or an end of a door molding is fitted into the recess, thereby holding the vehicle-exterior side wall.

7. The automotive glass run according to claim 1, wherein a low sliding resistance material layer is formed on a surface of the vehicle-exterior seal lip and a surface of the vehicle-interior seal lip.

8. The automotive glass run according to claim 1, wherein a low sliding resistance material layer is formed on a surface of the bottom wall.

9. The automotive glass run according to claim 1, wherein a cover lip is formed on a leading end of the vehicle-interior side wall, and the cover lip contacts a side edge of a garnish attached to a vehicle-interior side edge of the door frame or a vehicle-interior side of the door frame.
